(19) United States
(12) Patent Application Publication
(10) Pub. No.: US 2023/0234863 A1
(43) Pub. Date: Jul. 27, 2023

(54) PURE WATER PRODUCTION METHOD

(71) Applicant: KURITA WATER INDUSTRIES LTD., Tokyo (JP)

(72) Inventors: Yuu TANAKA, Tokyo (JP); Nozomu IKUNO, Tokyo (JP)

(73) Assignee: KURITA WATER INDUSTRIES LTD., Tokyo (JP)

(21) Appl. No.: 18/008,955

(22) PCT Filed: Mar. 24, 2021
(86) PCT No.: PCT/JP2021/012135

§ 371 Date: Dec. 7, 2022

(30) Foreign Application Priority Data
Jun. 10, 2020 (JP) 2020-101035

(51) Int. Cl. C02F 1/469; B01D 61/12; B01D 61/04; C02F 5/08

(52) U.S. Cl. CPC C02F 1/4695; B01D 61/12; B01D 61/04; C02F 5/08; C02F 2209/06; C02F 2209/05; C02F 2103/04

(57) ABSTRACT

A pure water production method for producing pure water by decarboxylating water to be treated under acidic conditions and then deionizing the result by using a reverse osmosis membrane separation device, the pH of inflow water flowing into the reverse osmosis membrane separation device and the water quality of permeated water of the reverse osmosis membrane separation device being measured, and the pH of the inflow water being adjusted on the basis of the measured pH and water quality so that the water quality of the permeated water is within a prescribed range, wherein the pH of the inflow water is changed by a predetermined width, and an operation condition adjusting step is performed for adjusting the pH of the inflow water by comparing the(average value before the water quality change average value after the water quality change.

### TECHNICAL FIELD

The present invention relates to a pure water production method of deionizing water to be treated using a reverse osmosis membrane separation device (which may hereinafter be referred to as an RO device) after the water to be treated is decarboxylated under acidic conditions.

### BACKGROUND ART

In the related art, as a method of producing pure water from water to be treated such as city water, well water, industrial water, recycled water, or the like, there is a method of adding acid to the water to be treated and decarboxylating the water to be treated in a deaerator, adding alkali to the decarboxylated water, and treating the decarboxylated water using an RO membrane separator (Patent Literatures 1 to 3). Further, since CO₂ assumes a CO₂ gas form when pH is low, alkali is added to effluent water of the decarboxylation apparatus (supplied water of the RO device) and removed in an ion form through RO treatment.

In a production method of pure water by such decarboxylation treatment and RO treatment, since optimum pH of RO supplied water (inflow water) varies depending on water quality of the water to be treated, a type of the RO membrane used, or the like, and a pH range in which a specific resistance of the obtained pure water (permeated water) is sufficiently high is often narrow, pH control is an extremely important requirement for improving the water quality of the permeated water.

Patent Literature 1 discloses a pure water production method of deionizing raw water using an RO device after decarboxylating the raw water under acidic conditions, the pure water production method including measuring pH of inflow water flowing into the RO device and a specific resistance of permeated water of the RO device, and adjusting the pH of the inflow water to increase the specific resistance value on the basis of a relation curve between the measured pH value and specific resistance value.

### CITATION LIST

### Patent Literature

[Patent Literature 1]

Japanese Patent Laid-Open No. H10-309574

[Patent Literature 2]

Japanese Patent Laid-Open No. H08-39066

[Patent Literature 3]

Japanese Patent Laid-Open No. 2000-189760

In the method of Patent Literature 1, when raw water quality changes while the relation curve between the pH value and the specific resistance value is obtained, the pH of the inflow water of the RO supplied water may deviate from an appropriate value and the water quality of the permeated water may deteriorate.

### SUMMARY OF INVENTION

### Technical Problem

The present invention is directed to providing a pure water production method capable of making permeated water always have good water quality.

### Solution to Problem

A pure water production method of the present invention is a pure water production method of deionizing water to be treated using a reverse osmosis membrane separation device after performing a decarboxylation treatment of the water to be treated under acidic conditions, the pure water production method including: measuring pH of inflow water flowing into the reverse osmosis membrane separation device and water quality of permeated water of the reverse osmosis membrane separation device; and adjusting the pH of the inflow water such that the water quality of the permeated water is within a predetermined range on the basis of the measured pH and water quality, wherein the pH of the inflow water is changed by a predetermined width, and an operation condition adjusting step of comparing an average value of water quality of the permeated water of a predetermined time after the pH change (an average value before water quality change) and an average value of water quality of the permeated water of a predetermined period after a predetermined time elapses after the pH change (an average value after water quality change) and adjusting the pH of the inflow water.

In the aspect of the present invention, the water quality is a specific resistance, a conductivity or a Na concentration.

In the aspect of the present invention, the predetermined width of the pH is a value selected from 0.01 to 0.1, the predetermined time is a value selected from 5 min to 15 min, and the predetermined period is a value selected from 1 min to 10 min.

In the aspect of the present invention, the operation condition adjusting step is performed periodically.

In the aspect of the present invention, when the water quality average value before the change is outside a predetermined range, the operation condition adjusting step is performed.

In the aspect of the present invention, the decarboxylation treatment is performed such that an inorganic carbonic acid concentration of the decarboxylated water is less than 15 mg/L.

In the aspect of the present invention, a scale inhibitor is added to water to be treated before the decarboxylation treatment.

### Advantageous Effects of Invention

In the pure water production method of the present invention, since a pH of RO inflow water is adjusted by comparing a water quality average value of RO permeated water of a predetermined time after the pH of the RO inflow water is changed by a predetermined width and a water quality average value of RO permeated water of a predetermined period after a predetermined time elapses from the pH change, even when there is a short-term change in the water quality of water to be treated, the pH of the RO inflow water becomes an appropriate value, and RO permeated water with stable and good water quality can be produced.

### BRIEF DESCRIPTION OF DRAWINGS

FIG. 1 is a flow diagram showing a pure water production apparatus.

FIG. 2 is a graph showing a test result.

FIG. 3 is a graph showing a test result.

### DESCRIPTION OF EMBODIMENTS

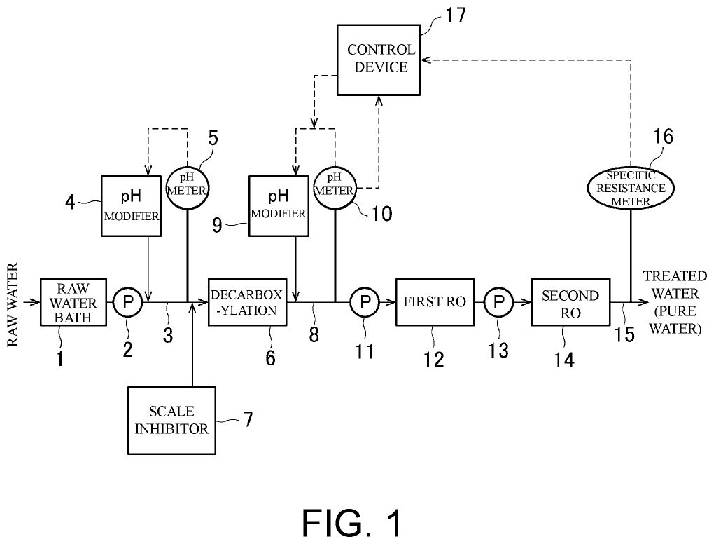

An embodiment of the present invention will be described in detail with reference to the accompanying drawings. FIG. 1 shows an example of a pure water production apparatus to which a pure water production method of the present invention is applied. Further, in the apparatus of FIG. 1, deionization treatment is performed by sequentially passing water through RO devices arranged in series in two stages, but the RO devices may be installed on only one stage or in three or more stages.

City water, industrial water, well water, recycled water, or the like, or water to be treated (raw water) obtained by performing pre-treatment such as clarification or the like according to necessity on these is sent from a raw water bath 1 to a pipeline 3 by a pump 2. After acid is added to the water to be treated flowing through the pipeline 3 from a first pH modifier adding means 4, decarboxylation treatment is performed by a decarboxylation apparatus 6. A decarbonator, a membrane deaerator, or the like may be employed as the decarboxylation apparatus 6.

A pH of the supplied water in the decarboxylation apparatus 6 is measured by a pH meter 5, and acid is added such that the measured value comes within a predetermined range. In the decarboxylation apparatus 6, while it is preferable that the pH of the supplied water be low in order to remove a carbonate ingredient in the form of CO₂ gas under acidic conditions, the pH is preferably 4 to 6, in particular 5 to 6 because an ion load (for example, H₂SO₄) is applied to the RO device in the latter stage by a pH modifier when the pH is lowered too much.

In addition, in the embodiment, a scale inhibitor is added to the water to be treated in the pipeline 3 from an adding means 7.

The effluent water in the decarboxylation apparatus 6 flows out through a pipeline 8, alkali is added by a second pH modifier adding means 9, and then the water passes through a first RO device 12 via a first high pressure pump 11. The pH of the inflow water in the first RO device 12 is measured by a pH meter 10, and the measured value is transmitted to a control device 17.

The effluent water of the first RO device 12 passes through a second RO device 14 via a second high pressure pump 13 and is deionized, and treated water (pure water) is removed via a pipeline 15. A specific resistance meter 16 configured to measure water quality (in the embodiment, a specific resistance) of the obtained pure water is provided on the pipeline 15, and the detected value is input to the control device 17.

The control device 17 controls a second pH adjusting means 9 such that a specific resistance of the pure water comes within a predetermined range on the basis of the measured specific resistance value of the specific resistance meter 16.

The control device 17 operates the second pH adjusting means 9 and changes the pH of the inflow water of the first RO device 12 detected by the second pH meter 10 within a predetermined width periodically (a first aspect) or when a permeated water specific resistance average value is outside the predetermined range (a second aspect). Then, after a predetermined time elapses, specific resistances detected by the specific resistance meter 16 throughout the predetermined period are averaged to obtain an average value, and pH change of first RO inflow water is performed on the basis of the result. Hereinafter, the first aspect and the second aspect will be described.

### <First Aspect: Aspect of Changing pH of First RO Inflow Water Periodically>

In the first aspect of the present invention, the control device 17 operates the second pH adjusting means 9 periodically (for example, at a frequency of once every 5 to 20 min, in particular 10 to 15 min), and changes the pH of the inflow water of the first RO device 12 detected by the second pH meter 10 within a predetermined width. The predetermined width is preferably a value selected form a range of 0.01 to 0.1, in particular 0.01 to 0.05. A direction of the pH change may be to a higher pH or to a lower pH.

As described above, after a predetermined time t elapses after the pH of the inflow water in the first RO device 12 is changed within a predetermined width, the specific resistances detected by the specific resistance meter 16 are averaged throughout a predetermined period T to obtain an average value (which may hereinafter be referred to as a specific resistance average value after the water quality change). The predetermined period T is preferably a value selected from a range of 1 to 10 min, in particular 1 to 5 min. In addition, the predetermined elapsed time t is preferably set according to the number of installation stages of the RO device or the capacity of the RO device, or normally, is preferably a value selected from a range of 3 to 15 min, in particular 5 to 10 min per two stages of the RO device 2.

When the specific resistance average value after the water quality change is lower than a permeated water specific resistance average value in a predetermined time immediately after the pH change (which may hereinafter be referred to as a specific resistance average value before a water quality change), the next pH change is reversed from the current change direction.

When the specific resistance average value after the water quality change is equal to or higher than the specific resistance average value before the water quality change, a direction of the next pH change is the same as the current change direction.

In this way, control of periodically changing the pH of the first RO inflow water within a predetermined width to obtain the specific resistance average value after the water quality change and increasing the permeated water specific resistance by performing the next pH change of the first RO inflow water on the basis of the result is performed. In particular, by comparing the permeated water specific resistance average values in the predetermined periods after the pH change of the first RO inflow water, even when the water quality of the water to be treated is temporarily changed, the pH of the first RO inflow water can be appropriately controlled.

### <Second Aspect: Aspect of Changing pH of First RO Inflow Water When Permeated Water Specific Resistance Average Value is Outside Predetermined Range>

In the second aspect of the present invention, the control device 17 changes the pH of the first RO inflow water within the predetermined width when the detected specific resistance of the specific resistance meter 16 (preferably, an average value in the predetermined period (preferably, 1 to 10 min, particularly, 1 to 5 min)) is outside the predetermined range. The pH change direction in this case may be either on the higher side or the lower side.

After the pH change in the same manner as the case of the first aspect, the specific resistance average value after the water quality change is obtained. Then, the following control of (i) or (ii) is performed on the basis of the result.

(i) When the obtained specific resistance average value after the water quality change is within the predetermined range (the specific resistance is a prescribed value or more), after that, an operation in this state is continued until the detected specific resistance of the specific resistance meter 16 (preferably, an average value in the predetermined period) is outside the predetermined range.

(ii) In the case in which the obtained specific resistance average value after the water quality change is still outside the predetermined range (less than the prescribed value), when the specific resistance average value after the water quality change is smaller than the specific resistance average value before the water quality change, the pH of first RO inflow water is changed to a direction opposite to the current change direction, and when greater than the specific resistance average value before the water quality change, the pH of the first RO inflow water is changed to the same direction as the current change direction. Then, the specific resistance average value after the water quality change in the predetermined period (hereinafter, may be referred to as the specific resistance average value after the water quality change again) is obtained after the predetermined time elapses from the pH change again.

When the specific resistance average value after the water quality change is within the predetermined range again, the operation in this state is continued. When the specific resistance average value after the water quality change is still outside the predetermined range again, the above-mentioned control is repeated until the specific resistance average value after the change is within the predetermined range. Accordingly, it is possible to produce pure water while the specific resistance is within the predetermined range.

In the embodiment, while the specific resistance as the water quality is used, the water quality other than the specific resistance may be acceptable. Conductivity, Na concentration, inorganic carbonic acid (IC) concentration, or the like, is exemplified other than the specific resistance. However, since the IC requires time to measure, the specific resistance, the conductivity or the Na concentration is preferable. In the case of the IC, the conductivity and the Na concentration, since the water quality is improved as the value becomes lower, according to thereto, the control in the first and second aspects is performed.

In the present invention, when the specific resistance of the produced pure water is lower than the target value and the pH is greatly (more than pH 1) separated from the target value, the pH of the RO inflow water may be brought close to the target pH rapidly by PID control.

In the present invention, the pH of the supplied water for the decarboxylation treatment may be the IC concentration (less than 15 mg/L) of the decarboxylated water that can secure the specific resistance that becomes a target of the RO treated water, or may not be lowered to the pH 4.0 to 5.0 that is appropriate in Patent Literature 1. By doing so, it is possible to reduce the amount of acid added before the decarboxylation treatment.

In the present invention, a non-pulsation pump is preferably used in a chemical feeding pump of the pH adjusting means.

In the present invention, when the operation of the pure water production apparatus is started, the next procedure is preferably performed.

First, the pH of the supplied water in the decarboxylation apparatus is set to a specified value from 6.0 to 7.0, for example, 6.5, a relation between the pH of the RO supplied water and the RO treated water quality is determined, and it is confirmed whether the target RO treated water quality can be secured.

If the target value cannot be secured, the pH of the decarboxylation equipment is lowered to a predetermined value, for example, a value selected from 0.3 to 0.7, specifically, for example, 0.5, a relation between the pH of the RO supplied water and the

RO treated water quality is determined again.

This is repeated, and the pH of the supplied water in the decarboxylation apparatus in which decarboxylation capable of securing the target value is performed is determined. Then, upon an operation after that, the pH of the RO supplied water is controlled by the method of the first or second aspect.

### EXAMPLES

### Experiment Example 1

In the flow shown in FIG. 1 (however, a preservation filter was installed at a front stage of the first RO), the following flow examination was performed, and a relation between the pH of the RO inflow water (supplied water), the permeated water specific resistance and the IC (inorganic carbon concentration) was obtained.

Main conditions are as follows.

First RO recovery rate: 75%

Second RO recovery rate: 90%

Water to be treated: Town water of Nogi was treated with activated carbon to remove chlorine.

Chemicals: 2.5 mg/L of scale inhibitor (Kuriverter N500 manufactured by Kurita Water Industries Ltd.) was added before decarboxylation treatment.

3 mg/L of slimicide (Kuriverter EC503 manufactured by Kurita Water Industries Ltd.) was added before preservation filter.

Sulfuric acid was added in the first pH adjusting means, and caustic soda was added in the second pH adjusting means.

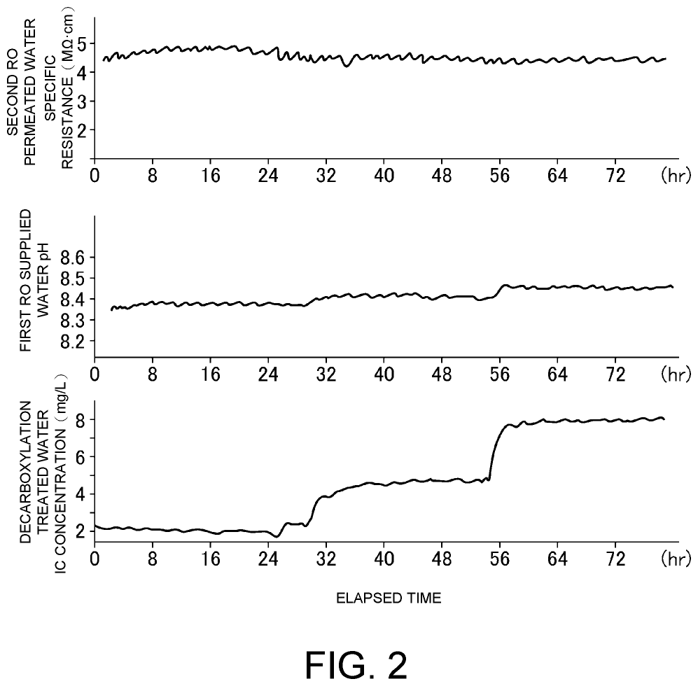

FIG. 2 shows a relation between the second RO treated water specific resistance, the pH of the first RO supplied water, and the deaeration treated water IC. During the period, while the deaeration (decarboxylation) treated water IC was increased stepwise to approximately 2.0, 4.5 and 8.0 mg/L by adjusting the pH of the decarboxylation apparatus supplied water to be higher per about 4.5, 6.2, 6.5 and 24 hours, the RO treated water specific resistance was maintained at 3.5 MΩ⋅cm or more by adjusting the pH of the first RO supplied water to 8.3 to 8.6, which is weakly alkaline.

### Experiment Example 2

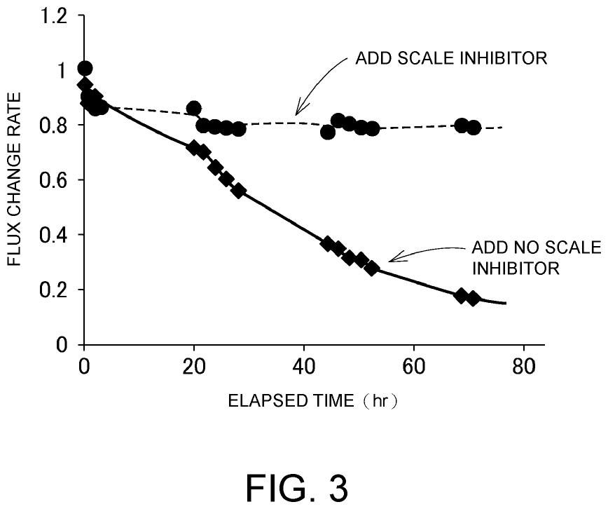

When the water passes through the RO membrane of the flat membrane testing device under the following condition and scale inhibitor (Kuriverter N500 (Kurita Water Industries Ltd.)) is added or not added, permeate flux (flux) of Ro was measured. The results are shown in FIG. 3.

### <Testing Condition>

Used membrane: ES20 (manufactured by Nitto Denko Corp.), using flat membrane testing device

Supplied water quality: acid consumption (pH4.8) 100 mg/L, CaH 200 mg/L, FeO 0.5 mg/L, aluminum ion 0.2 mg/L, pH 8.0, EC503 (slime control agent) 3mg/L

Recovery rate: 80%

As shown in FIG. 3, clogging of the RO membrane is suppressed by adding the scale inhibitor.

While the present invention has been described in detail using the specified aspect, it will be apparent to those skilled in the art that various modifications may be made without departing from the sprit and scope of the present invention.

Priority is claimed on Japanese Patent Application No. 2020-101035, filed Jun. 10, 2020, the content of which is incorporated herein by reference.

### REFERENCE SIGNS LIST

6 Decarboxylation apparatus

12 First RO device

14 Second RO device

1. A pure water production method of deionizing water to be treated using a reverse osmosis membrane separation device after performing a decarboxylation treatment of the water to be treated under acidic conditions, the pure water production method comprising:
measuring pH of inflow water flowing into the reverse osmosis membrane separation device and water quality of permeated water of the reverse osmosis membrane separation device; and
adjusting the pH of the inflow water such that the water quality of the permeated water is within a predetermined range on the basis of the measured pH and water quality,
wherein the pH of the inflow water is changed by a predetermined width, and
an operation condition adjusting step of comparing an average value of water quality of the permeated water of a predetermined time after the pH change (hereinafter referred to as an average value before water quality change) and an average value of water quality of the permeated water of a predetermined period after a predetermined time elapses after the pH change (hereinafter referred to as an average value after water quality change) and adjusting the pH of the inflow water.

2. The pure water production method according to claim 1, wherein the water quality is a specific resistance, a conductivity or a Na concentration.

3. The pure water production method according to claim 1, wherein the predetermined width of the pH is a value selected from 0.01 to 0.1, and
the predetermined time is a value selected from 5 min to 10 min, and the predetermined period is a value selected from 1 min to 5 min.

4. The pure water production method according to claim 1, wherein the operation condition adjusting step is performed periodically.

5. The pure water production method according to claim 4, wherein the water quality is a specific resistance,
when the average value after the water quality change is lower than the average value before the water quality change, a direction of next pH change is reversed from a current change direction, and
when the average value after the water quality change is the average value before the water quality change or more, the direction of the next pH change is the same as the current change direction.

6. The pure water production method according to claim 4, wherein the water quality is a conductivity or a Na concentration,
when the average value after the water quality change is higher than the average value before the water quality change, a direction of next pH change is reversed from a current change direction, and
when the average value after the water quality change is the average value before the water quality change or less, the direction of the next pH change is the same as the current change direction.

7. The pure water production method according to claim 1, wherein, when the average value before the water quality change is outside a predetermined range, the operation condition adjusting step is performed.

8. The pure water production method according to claim 7, wherein, when the average value after the water quality change is within the predetermined range, the pH of the inflow water is maintained as it is.

9. The pure water production method according to claim 7, wherein the water quality is a specific resistance,
when the average value after the water quality change is lower than the average value before the water quality change, a direction of next pH change is reversed from a current change direction, and
when the average value of the water quality change is outside the predetermined range and equal to or greater than the average value before the water quality change, the direction of the next pH change is the same as the current change direction.

10. The pure water production method according to claim 7, wherein the water quality is a conductivity or a Na concentration, and
when the average value after the water quality change is higher than the average value before the water quality change, a direction of next pH change is reversed from a current change direction, and
when the average value after the water quality change is outside the predetermined range and equal to or smaller than the average value before the water quality change, the direction of the next pH change is the same as the current change direction.

11. The pure water production method according to claim 1, wherein the decarboxylation treatment is performed such that an inorganic carbonic acid concentration of the decarboxylated water is less than 15 mg/L.

12. The pure water production method according to claim 1, wherein a scale inhibitor is added to water to be treated before the decarboxylation treatment.
